(19) United States
(12) Patent Application Publication
(10) Pub. No.: US 2014/0095801 A1
(43) Pub. Date: Apr. 3, 2014

(54) SYSTEM AND METHOD FOR RETAINING COHERENT CACHE CONTENTS DURING DEEP POWER-DOWN OPERATIONS

(71) Applicants: Devadatta V. BODAS, Federal Way, WA (US); Zhong-Ning (George) CAI, Lake Oswego, OR (US); John H. CRAWFORD, Saratoga, CA (US)

(72) Inventors: Devadatta V. BODAS, Federal Way, WA (US); Zhong-Ning (George) CAI, Lake Oswego, OR (US); John H. CRAWFORD, Saratoga, CA (US)

(21) Appl. No.: 13/631,582

(22) Filed: Sep. 28, 2012

(51) Int. Cl. G06F 12/08

(52) U.S. Cl. CPC G06F 12/0891
USPC 711/135

(57) ABSTRACT

A system, method, and computer program product for retaining coherent cache contents during deep power-down operations, and reducing the low-power state entry and exit overhead to improve processor energy efficiency and performance. The embodiments flush or clean the Modified-state lines from the cache before entering a deep low-power state, and then implement a deferred snoop strategy while in the powered-down state. Upon existing the powered-down state, the embodiments process the deferred snoops. A small additional cache and a snoop filter (or other cache-tracking structure) may be used along with additional logic to retain cache contents coherently through deep power-down operations, which may span multiple low-power states.

### FIELD OF THE INVENTION

The embodiments of the present invention relate to power and memory management in microprocessors, and in particular to retaining cache coherency during deep power-down operations.

### BACKGROUND

Computer system design involves several tradeoffs to maximize performance while minimizing cost. For example, for many years effective processor speeds have been increasing faster than those of the various memory systems that supply them with data and instructions. One widely used strategy for addressing this discrepancy is to use intermediate memories, called caches, to store information for immediate use while slower data exchanges with a main memory are occurring.

A small cache, often called a level zero or L0 cache, may be integrated close to the processor's core pipeline to provide fast access to instructions and selected data. Larger caches (so-called L1, L2, etc. caches, out to the last-level caches or “LLC”) accommodate increasingly larger portions of the working data set but typically require more time to access the data. Cost and performance constraints of different sizes and types of cache memories often lead designers to organize the overall memory system into a hierarchy of storage structures, including the main memory and one or more cache levels. Data requests are preferably satisfied from the lowest level of the memory hierarchy that holds the needed information, for efficiency.

A copy of data in the cache is often referred to as a cache line. This data represents a portion of the data in the main memory. If the data is changed in the main memory, data in the cache may no longer be current, and should not be used by the processor because it is stale. A similar problem exists if the data in the cache is changed, but the change has not yet propagated to all other portions of the memory hierarchy. A memory system is said to be coherent if any read of a data item returns the most recently written value of that data item. Coherent caches provide replication and migration of shared data items. Various techniques have been developed to ensure cache coherency. For example, when the data in one cache is modified, other copies of the data may be marked as invalid so that they will not be used.

Power management is another major area of design tradeoff in computer system design. Mobile, i.e. battery-powered, computing devices are becoming more prevalent in modern society. Tradeoffs between performance and power consumption will increasingly lead to computing systems that use fast processors to provide needed computing capacity, but only when needed. Existing power management schemes currently put central processing units (CPUs) into various lower power states whenever lower performance is acceptable, to extend battery life and keep circuitry operating temperatures down.

A set of industry standard lower power states is described in the Advanced Configuration and Power Interface (ACPI) specification, the most recent version of which (5.0) was published on Dec. 6, 2011. The ACPI power states are defined as:
C0 is the fully operating state.
C1 (Halt) is a state where the processor is not executing instructions, but can return to an executing state essentially instantaneously. All ACPI-conformant processors must support this power state. Some processors also support a CIE or Enhanced Halt State for even lower power consumption.
C2 (Stop-Clock) is a state where the processor maintains all software-visible states, but may take longer to awaken.
C3 (Sleep) is a state where the processor does not need to keep its cache coherent, but maintains other states. Some processors have variations on the C3 state that differ in how long it takes to wake the processor.

Cache coherency maintenance is complicated by the need to share data among multiple processors, as the operation of some processors might be dependent on the operation of others. For example, consider a system in which two or more processors cooperate to complete system tasks. If one processor has been powered-down, another processor in the system may continue to perform data transactions on the system bus. Some transactions may attempt to read or write data stored in a modified state in a powered-down processor. Unless some mechanism exists for monitoring bus activity and updating shared memory locations for inactive processors, data coherency will be lost. Therefore, an improved system and method for retaining cache coherency during deep power-down operations is needed.

### BRIEF DESCRIPTION OF THE DRAWINGS

FIG. 1 depicts an exemplary system embodiment with multiple processor cores, each with separate index and data L0 caches and a unified mid-level cache (“MLC”), connecting to a large, shared LLC in front of the main memory, according to an aspect of the present invention.

FIG. 2 depicts an exemplary system embodiment with no shared LLC, and a snoop filter is used to track the contents of the pairwise-shared MLCs to filter snoops driven in from other sockets, or from processor cores in the same socket within a different core-pair (and shared MLC), according to an aspect of the present invention.

FIG. 3 is an exemplary flowchart depicting the basic operations of a method embodiment, according to an aspect of the present invention.

FIG. 4 is an exemplary flowchart depicting more detailed operations of the method embodiment of FIG. 3, according to an aspect of the present invention.

FIG. 5 is an exemplary flowchart depicting further detailed operations of the method embodiment of FIG. 3, according to an aspect of the present invention.

FIG. 6 is a diagram of an exemplary computer system to implement various embodiments, according to an aspect of the present invention.

### DETAILED DESCRIPTION

The problem of cache coherency management is currently avoided during deep low power states by simply flushing cache contents out to a higher level of the memory hierarchy. This allows a transition to a power-managed state that doesn't allow cache snoops to be performed. The result is increased energy usage for the transition, and reduced performance at exit from the deep power-down state due to the need to reload the flushed cache contents. Some current processors require that cache contents be flushed on entering deep low power states because the cache cannot respond rapidly enough to the snoops needed to maintain the consistency of all caches in the memory hierarchy. In particular, deep low power states that drop the operating voltage below the minimum voltage needed for reliable logic operation (in order to minimize leakage power) cannot ramp up to a stable minimal voltage value in time to respond to snoops from other caches in the memory hierarchy.

The need to flush the cache introduces several inefficiencies. First, the process of flushing the cache contents takes time (delaying entry to the deep powered-down state) and energy (counteracting the reason for using the deeply reduced power state in the first place). Second, upon exiting from the powered-down state, the cache is empty, requiring more time and energy to refresh the cache contents from higher levels (i.e. towards main memory) in the memory hierarchy. Using the C1 low power state does not resolve this issue fully, because in that state several blocks in a processor core remain powered on to snoop the processor core cache to maintain cache coherence, resulting in increased power drain. Reducing power further than is possible with just the C1 state is the motivation for the use of deeper C-states.

Similar issues are present for the cache shared between two processor cores integrated together. In a dual-core processor, two processor cores and their shared cache share a power plane. Power-gating the processor cores requires flushing of this shared cache. Because some dual-core devices have no LLC, the flushes must be pushed out to main memory, and upon wakeup the cache must be refilled from main memory. As the number of processor cores increases, it is likely that these problems will worsen. More cache flush operations will add to the on-chip interconnect traffic, reducing performance of the other processor cores, and increasing on-chip interconnect energy use. As described more fully below, the embodiments disclosed permit improved cache coherency during deep power-down operations in a computer system such as, for example, a mobile computing device.

The management of cache coherency depends on the state of the cache lines involved. Cache states are often described in terms of so-called MESI cache states (an acronym for Modified, Exclusive, Shared, Invalid):

Modified—The cache line is a current copy of a modified line, is present only in the current cache, and is “dirty” meaning the line is more current than the corresponding “stale” data line in main memory. The cache updates the main memory with the current data residing in the cache before discarding it. Such write-back caches have a major drawback when used in a shared memory multiprocessor system. In scenarios where the write-back cache has a dirty cache line and another CPU issues a read request for the same memory address, this request cannot be served by the main memory yet, as it contains stale data. As a modified or exclusive line is exclusively associated (e.g., owned or modified) with one of the caches, the modified and exclusive states may be combined into an “E/M” state.

Exclusive—The cache line is a current copy of the main memory contents, and is present only in the current cache that has obtained ownership of the line. In other words, no other cache has a copy of the line in the modified, exclusive, or shared state and hence no bus transaction is necessary if the owning processor subsystem writes the line. This reduces bus traffic considerably in applications that modify private data.

Shared—The cache line is a current copy of the main memory contents, and may be present in one or more other caches. If a cache line needs to be written by a CPU, a broadcast message must be placed in the bus only when the cache line is in a shared state.

Invalid—The cache line is not a current copy and thus does not contain any valid data. The current copy may reside in memory and/or one of the other caches in the remote processor nodes.

In so-called “snoop” based coherency management protocols, every cache monitors the address lines of a shared bus for every memory transaction made by remote processors. A coherency controller may track the states of cache lines with its proxying snoop filter, which is a small cache-like structure. The snoop filter tracks a copy of the cache tags of one or more caches at inner levels between the cache and the bus. The snoop filter processes snoop traffic to proxied caches; a “miss” in the snoop filter guarantees that no cache the snoop filter is proxying has a line of interest, and a “hit” means the snoop induced look-up needs to be forwarded to the cache that has the data. Snoop filters often track which cache has the data, so it can forward the snoop to the affected caches directly. Appropriate action is taken when locally cached data is modified by a transaction initiated by a remote processor. For example, a write attempt by a remote processor into a locally cached data address requires the remote processor to get ownership of the line (which requires snoops) and then results in an invalidation of the local cache copy. All the other processors on the bus snoop and take appropriate action (e.g., invalidation of the local cache copy, etc.). The bus transaction is ignored in case the snoop resulted in a cache miss.

Snooping for requested cache lines is often performed to preserve cache coherency in a multi-processor core system. In a multi-level cache system, this would in general mean that snoop messages would need to be propagated downward, starting at the last-level caches and continuing all the way down to the L1 caches. Many caches are designed to be inclusive, however, partially to reduce the latency resulting from snoop messages. An inclusive cache maintains the property that any cache line present in a lower-level cache is in that inclusive cache. Therefore, snooping in many circumstances may need only be performed to the last-level caches; i.e. if a particular cache line is not present in the last-level cache, then by the inclusive property it will not be present in any lower-level caches either. The last-level cache may be inclusive. The inclusive property permits simplified snooping for ensuring cache coherency, as one only needs to snoop to the inclusive cache and not to any lower-level caches to determine whether a particular cache line is present.

Briefly then, the embodiments to be described below flush out or clean all the Modified lines from the cache before entering a deep low-power state, and then implement a deferred snoop strategy to handle external inquiries while the processor is powered-down. The deep low-power state of the embodiments is referred to hereafter as the “C1+” state to distinguish it from different known low-power states already in use.

The rationale of the embodiments is that if the Modified lines are removed from the cache, then snoops to a sleeping processor core are relieved of timing pressure. In other words, only Modified lines require that the cache be accessed to retrieve the only copy of the Modified line and to pass it to a new owner. Therefore, during entry to the low-power state, Modified cache lines are eliminated by flushing or cleaning such that all lines in the cache are either marked as invalid or are clean copies, respectively. Cache lines may be cleaned by performing a write back, and changing their status to Exclusive or Shared.

Snoops to Shared or even Exclusive lines may be handled by queuing each such snoop for later processing into the cache, and simply returning a “snoop completed” response to the snooper. The queue may then be actually processed later. Logic and state memory outside the cache may track the contents of the cache, and thus act as a snoop proxy during powered-down status. This logic and state memory might only comprise a small addition to a core-valid structure in a higher level (i.e. outer) inclusive cache, or a snoop filter for a non-inclusive cache or LLC.

While in the C1+ low-power state, the external logic and state memory will act as a proxy to the cache to track memory references by other agents, e.g. another processor or its supporting logic circuits. If a reference is made to memory held in the cache, the cache proxy will a) respond to the snoop so that the other agent can continue, b) update the proxy cache line state if necessary, and c) possibly append a snoop to the deferred snoop queue for later processing by the cache on exit from the low-power state.

Upon eventual exit from the C1+ low-power state, the deferred snoops are processed to update the cache, i.e. to reflect cache transactions managed by the snoop proxy logic during the duration of the C1+ low-power state. These snoops should be processed before any agents behind the cache can access memory through the cache. Note that some initialization of the agents behind the cache (such as a CPU core) may however occur in parallel to the processing of queued snoops.

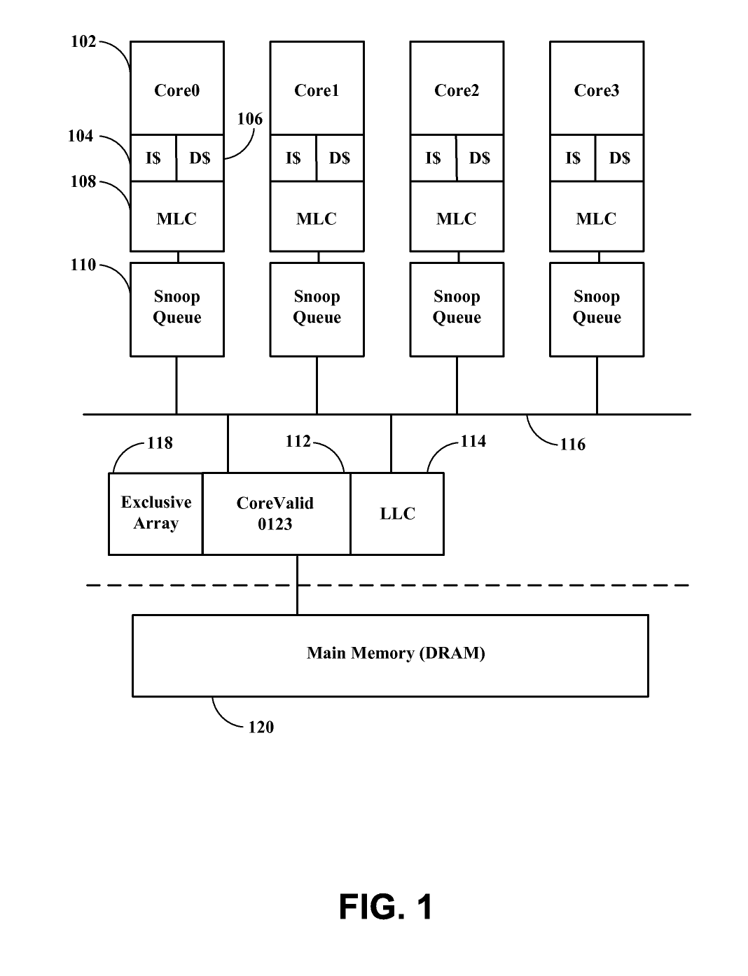

Referring now to FIG. 1, a diagram is shown of an exemplary system embodiment with multiple processor cores 102, each with separate instruction 104 and data 106 L0 caches and a unified MLC 108, connecting to a large, shared LLC 114 in front of the main memory 120. In this case, the embodiment is power-managing the MLC and L0 caches. The snoop queue 110 may be located between the MLC 108 and the shared LLC 114, with the location chosen based on chip floorplan considerations (e.g. space, power delivery, etc.). The location illustrated here is close to the MLC 108, between the interconnect network 116 and the MLC 108, but it could be elsewhere.

Also, in this example the LLC 114 is inclusive of the MLC/L0 cache contents, so that a simple core-valid bit array 112 is all that is needed for retaining state for the snoop proxy. A single bit per processor core in the core-valid bit array 112 may be kept for each cache line, and indicates if the corresponding processor core contains a copy of that line. An additional bit in an exclusive array 118 may denote whether the cache line is in an exclusive state.

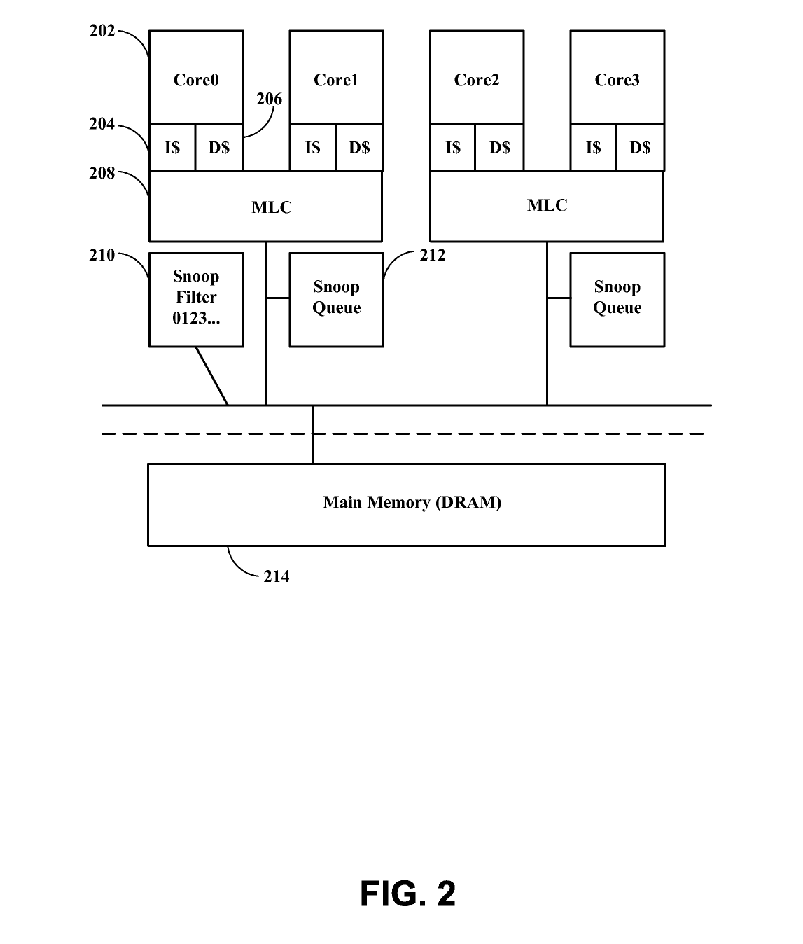

Referring now to FIG. 2, a diagram is shown of an exemplary embodiment that is somewhat similar to FIG. 1 with processor cores 202, L0 caches 204 and 206, and snoop queue 212. However, this embodiment has no shared LLC, so a snoop filter 210 is used to track the contents of the pairwise-shared MLCs 208 to filter snoops from other sockets, or from processor cores in the same socket within a different core-pair (and shared MLC). In this case, snoop filter 210 will act as the snoop proxy. Also, in this case, once an MLC 208 is flushed (to enter a deep C-state), the corresponding memory state will be pushed out to main memory 214. This will incur a larger cost both for flushing the MLC 208 at entry to the C-state, and also after exiting the C-state, as the MLC contents will need to be refreshed from main memory 214, with its longer latency and higher energy costs than the previous example, which used the on-chip shared LLC. Snoop filter 210 may again include an additional bit in an exclusive array (not shown) to denote whether the cache line is in an exclusive state.

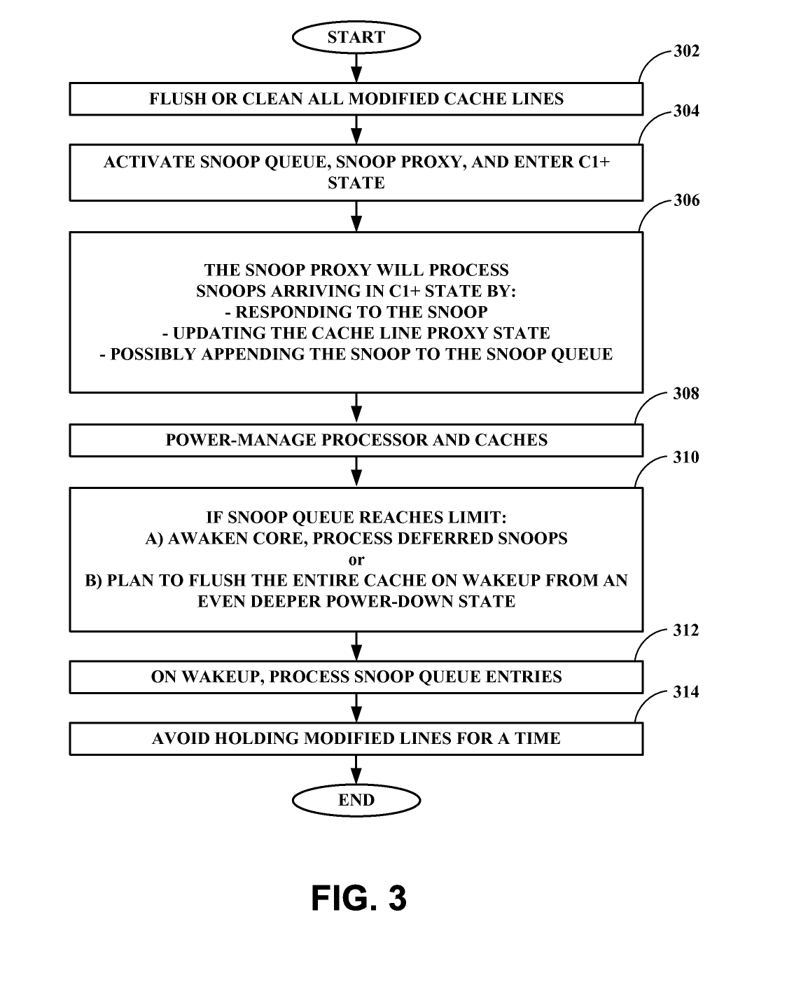

Referring now to FIG. 3, an exemplary flowchart is shown depicting the basic operations of a method embodiment. This embodiment may be implemented via integrated circuitry or by a processor executing instructions in a computer system; such instructions may be tangibly embodied in a computer-readable medium or computer program product.

First, at 302, the embodiment flushes or cleans Modified lines from the cache before entering the C1+ state. This will leave the cache with only Shared, Exclusive, or Invalid lines.

Second, at 304, the snoop queue and snoop proxy are activated, and the processor core enters the C1+ state. The embodiment provides or defines a queue to hold a number of snoop transactions that may arrive after the processor core goes into the C1+ state.

As part of the activation, the snoop proxy ensures that a snoop proxy records all lines that are retained in the sleeping processor's cache. The snoop proxy may comprise a snoop filter or LLC of core-valid bits, or another structure external to the cache that tracks the state of lines. There may be two options provided for the filter:

1) If all valid lines in the cache are marked as Shared, only one bit per processor core is needed, which indicates that the sleeping processor core has the line in Shared state (vs. Invalid). Since the snoop proxy bits are needed during the C0 state, the bits might have different meaning if the processor core is in the C0 state vs. another C-state. Thus, a simple tracker of processor core C-state status (only one n-bit vector for n processor cores) may be kept in the snoop proxy.

2) To distinguish Shared vs. Exclusive vs. Invalid states, since at most one processor core can have the cache line as Exclusive, an embodiment could just add one bit per cache line to indicate Exclusive status, and then use the core bit vector to mark the processor core that owns the cache line. This embodiment may also be used in the C0 state to track Modified as well as Exclusive lines.

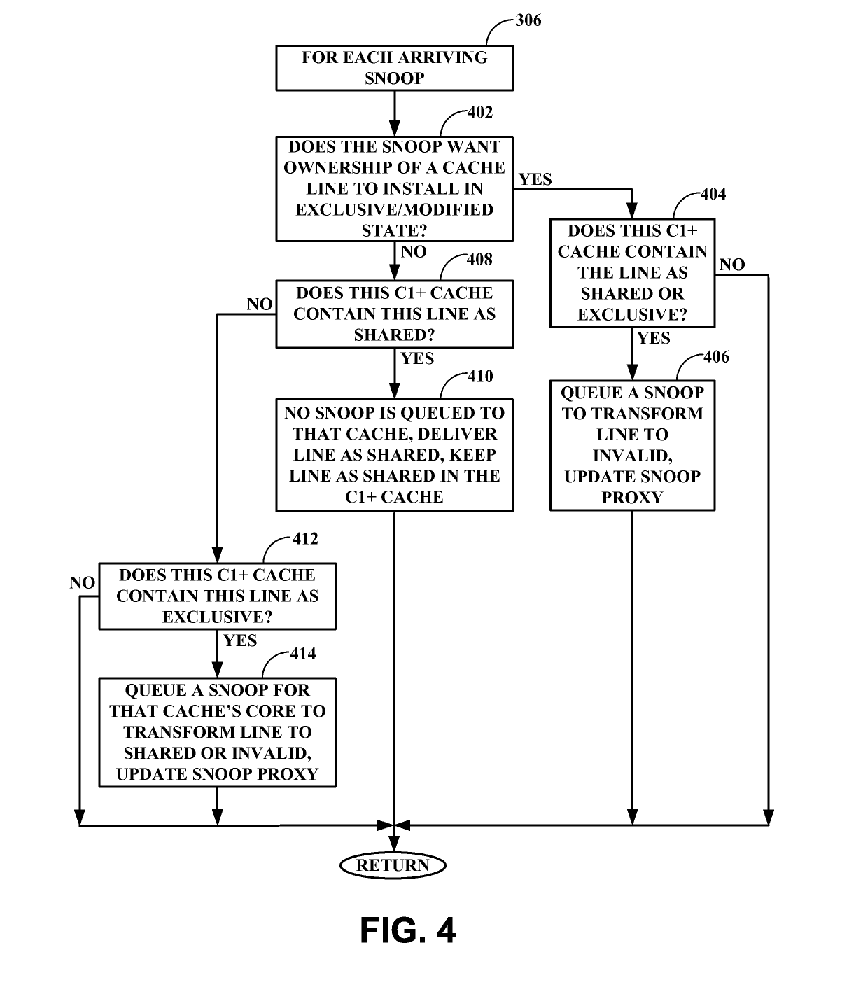

Third, at 306, for each snoop that comes in when a cache is in the C1+ state, the snoop proxy will respond to the snoop, update the cache line proxy state as necessary, and may append the snoop to the snoop queue. In this situation, shown in more detail in FIG. 4 described below, there are two general cases:

1) In order for a snoop to get ownership of a cache line (i.e. install it in an E/M state), determined at 402, it will need to add an Invalidate snoop to the deferred queue for any cache in the C1+ state that has that line, shown at 404. The snoop proxy would be updated by an embodiment to remove that cache line from the tracker (i.e. mark it as invalid) as if the snoop had completed normally, at 406. Since the cache in the C1+ state cannot deliver the cache line, the requestor will have to either get it from another cache, or from main memory.

2) In order for a snoop to get non-exclusive access to a cache line, some particular conditions may be evaluated as follows:

a. If no cache has the cache line, it may be speculatively delivered as Exclusive, or delivered as Shared. In either case, no action is needed by the snoop proxy since the line is already invalid (not present).

b. Otherwise, deliver the line as Shared to the requester (snooper), by evaluating the following logic:

1. If a cache in the C1+ state has the line as Shared, determined at 408, no snoop transaction should be queued to that cache; both caches will track the line as Shared, shown at 410.

2. If a cache in a C1+ state has the line as Exclusive, determined at 412, an Exclusive->Shared (or Exclusive->Invalid) snoop transaction should be queued at that processor core. The snoop proxy would then be updated to show the cache line as held as Shared (or cleared to Invalid), at 414.

3. If none of the awake caches (i.e. those in C0 or C1 states) have a copy of the line, the requestor will have to retrieve the line from main memory.

Fourth, (returning now to FIG. 3), while in the C1+ state, the cache and any logic behind it (e.g. processor core, and any inner-level caches, except for the snoop queue) may be power-managed at 308. For example, embodiments could:

a. Globally clock-gate the processor core, caches, and interface block, up to the on-chip interconnect. An embodiment could afford to have a few clock cycles to restart regional clocks since the snoop queue, and lack of Modified lines, removes the urgency of response.

b. In addition, take the processor core etc. to the retention voltage. This is attractive if the power delivery resumption is fast.

Sixth, at 310, if the snoop queue fills up or hits a high-water mark in the queue to accommodate a few extra snoops that might come during the wakeup time, embodiments may:

a. Wake up the processor core and process the deferred snoops. This would be appropriate if retaining the cache contents through the duration of the C1+ state is required.

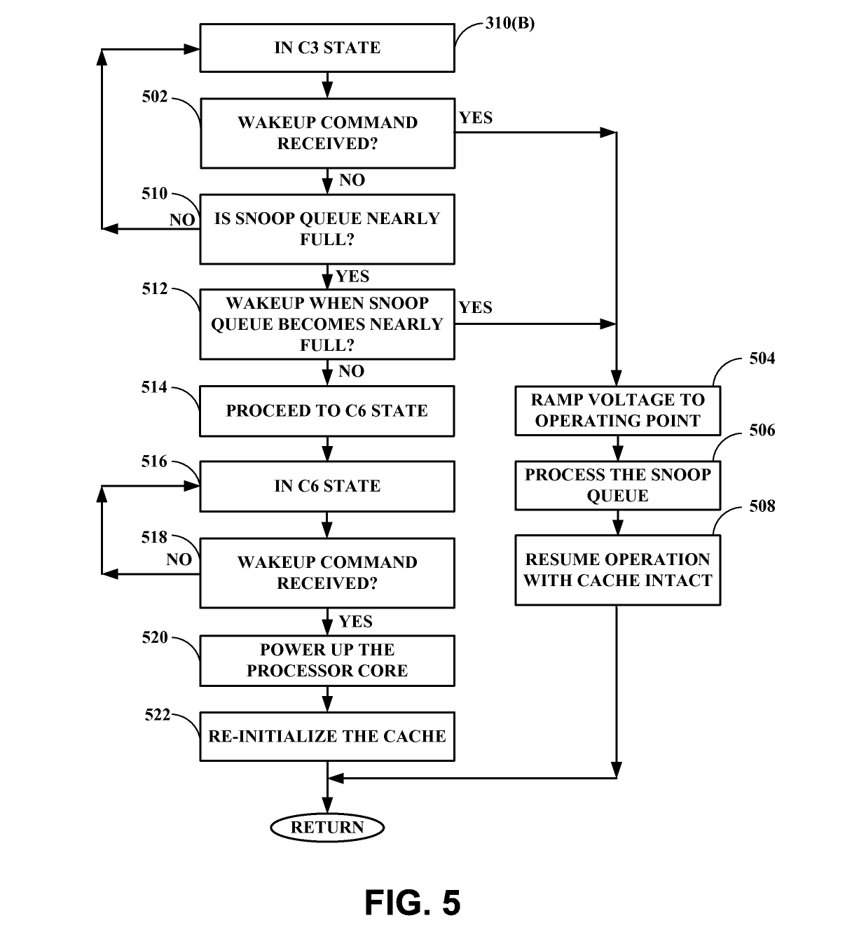

b. Give up on snooping and plan to flush the entire cache when the processor wakes up. This would be appropriate if the strategy is to gradually go to deeper C-states (e.g. delayed deep C-states). There are many possible embodiments for this latter behavior:
For example, at 310(A), one embodiment might start in a C1+ state until the snoop queue fills up (e.g. to a high-water mark). At that point, the embodiment may wake up the processor cores and process the snoop, and then go back to the C1+ state. C1+ state power management would be limited to relatively fast exit strategies such as clock gating, but the larger snoop queue should permit regional clock gating of almost all of the processor core logic and cache.
Another embodiment, at 312(B) may go to a deeper C1+ state, call it a C3 state, wherein the cache contents are preserved, but the cache and logic behind the cache (e.g. the processor core) are kept at the retention voltage. Two particular examples of this approach are now provided, described in more detail in FIG. 5:

1. If a wakeup command is received before the snoop queue fills up, determined at 502, an embodiment may ramp voltage back to the operating point at 504, process the snoop queue at 506, and resume operation with the cache intact at 508.

2. If the snoop queue is not full or nearly full, as determined at 510, operation returns to the C3 state. If the snoop queue fills up (e.g. to the high-water mark), determined at 510, then an embodiment may check to see if a wakeup is required when the snoop queue becomes nearly full at 512. If so, then the embodiment may proceed at 504 to wakeup as previously described. If instead a wakeup is not triggered when the snoop queue becomes nearly full, then an embodiment may transition at 514 to an even deeper state, call it state C6, to remove power from the cache/core to achieve the lowest power. The embodiment may remain in the C6 state if no wakeup command is received, as determined at 518. On receipt of a wakeup command from state C6 at 518, the embodiment may power up the processor core at 520 and re-initialize the cache at 522 anyway, so no extra time is required for the cache flush. This would be a good idea if the snoop queue is rather long, to support hundreds of microseconds of C1+ state duration. An embodiment may also use a C1+ timeout in conjunction with this practice.

Sixth, (returning now to FIG. 3) when the processor core comes out of the C1+ state at 312 (including when its snoop queue passes a high water mark), the snoops need to be pushed from the queue into the cache and all snoops processed before the processor core may resume execution. Note that this snoop processing may be performed along with activity local to the processor core, such as initializing/restoring its state to prepare for execution.

Seventh, at 314, to avoid a long entry latency into the C1+ state, one embodiment might implement a variation on the cache timer that would avoid holding a Modified line in the cache until a sufficient active time had passed. Before this timer expires, the cache would operate as a write-through cache: write hits would update the cache line and also push out the write to the outer levels of the memory hierarchy. This would keep the cache “clean” to avoid any entry latency for cleaning the cache before entering the C1+ state.

The deferred snoop queue may thus enable the processor core to go into and remain in a deeper sleep state than it otherwise might achieve, by lengthening the time the processor core can be power-managed by batching the snoops. The length of the deferred snoop queue would be a balance between several factors, including being:
long enough to buffer enough snoops to provide a meaningful power-down opportunity when the processor core is in C1+ state,
long enough to amortize the pipeline length of the snoop pipe. (For example, if the snoop pipeline is eight clocks long, a single snoop might keep the caches alive for eight to twelve clocks; but each back-to-back snoop might only add one or two clocks to the up time. Even a short queue of four to eight snoops could allow buffering of snoops to more efficiently process a group of snoops, rather than processing them one at a time.),
short enough to not add significantly to the exit latency of the C1+ state from processing the deferred snoops, and
short enough to meet area and power constraints.

A short snoop queue might allow regional clock gating and turning off the clock tree by covering a multiple-clock wakeup command to process snoops. On the other hand, the extra power saving opportunity might be too small to justify the cache cleaning and all of the overhead. Nonetheless, this embodiment might serve as a more comprehensive solution, if there is any power savings to be gleaned from clocking. Even in a processor core C1 state there might be power savings to be had by deferring snoops, but one would have to know there are no Modified state lines in the cache, or use the snoop proxy to track Modified state lines. An embodiment could even have the snoop proxy respond to Shared-to-Shared snoops without waking a processor core in C1 state (or even C0 state).

A queue to hold deferred snoops is not currently used for the purpose of these embodiments. Some caches may have a small (approximately five-entry) snoop queue to manage small bursts of snoops, but the embodiments described call for a much larger queue to hold tens of deferred snoops. Note, a 1 MB cache has 16K 64B lines, yet a 16K entry snoop queue is probably impractical. Experiments have shown a range of ten to 250 snoops per millisecond are directed to a sleeping processor core. At that rate, a 64-entry snoop queue might support roughly a few hundred microseconds to a few milliseconds of buffering time, which should be sufficient.

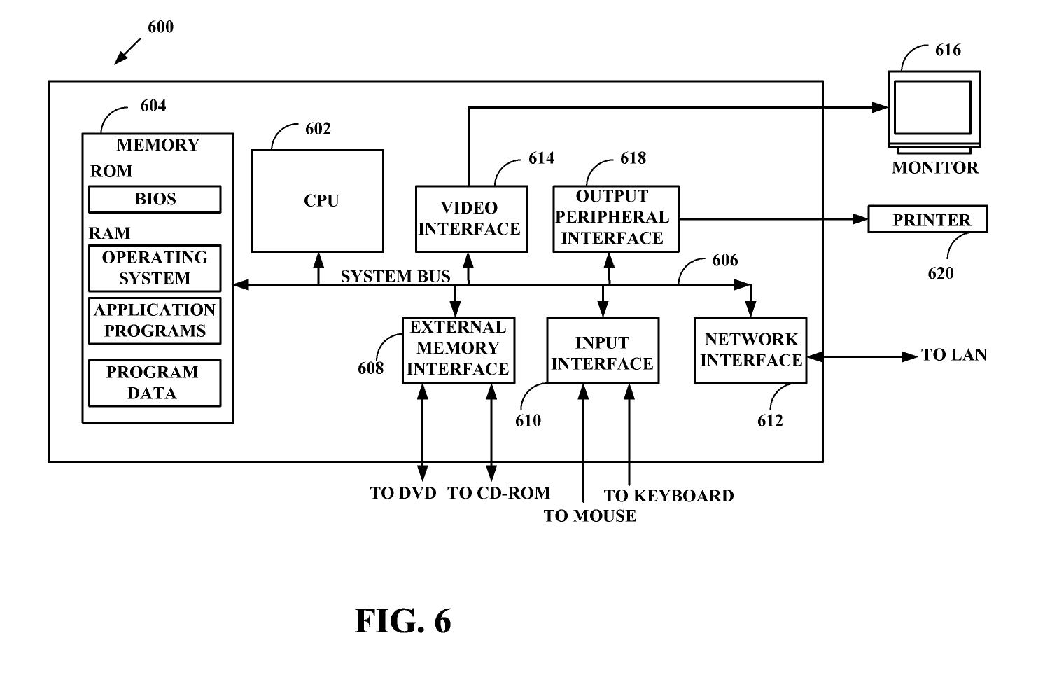

Referring now to FIG. 6, a computer system is depicted comprising an exemplary structure for implementation of the method embodiments described above; of course, it is possible that an integrated circuit implementation may have particular advantages. Computer system 600 comprises a central processing unit (CPU) or processor 602 that processes data stored in memory 604 exchanged via system bus 606. Memory 604 may include read-only memory, such as a built-in operating system, and random-access memory, which may include an operating system, application programs, and program data. Computer system 600 may also comprise an external I/O interface 608 to exchange data with a DVD or CD-ROM for example. Further, input interface 610 may serve to receive input from user input devices including but not limited to a keyboard, a mouse, or a touchscreen (not shown). Network interface 612 may allow external data exchange with a local area network (LAN) or other network, including the internet. Computer system 600 may also comprise a video interface 614 for displaying information to a user via a monitor 616 or a touchscreen (not shown). An output peripheral interface 618 may output computational results and other information to optional output devices including but not limited to a printer 620 for example via an infrared or other wireless link.

Computer system 600 may comprise a mobile computing device such as a personal digital assistant or smartphone for example, along with software products for performing computing tasks. The computer system of FIG. 6 may for example receive program instructions, whether from existing software products or from embodiments of the present invention, via a computer program product and/or a network link to an external site.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While particular embodiments of the present invention have been described, it is to be understood that various different modifications within the scope and spirit of the invention are possible. The invention is limited only by the scope of the appended claims.

What is claimed is:

1. A computer-implemented method for retaining coherent cache contents, comprising:
during a power-down operation, one of flushing and cleaning each modified cache line in a cache;
while in a powered-down state, deferring incoming snoops; and
upon exiting the powered-down state, processing the deferred snoops.

2. The method of claim 1 wherein deferring the incoming snoops further comprises:
capturing deferred snoops in a queue; and
with a snoop proxy:
tracking contents of the cache;
tracking memory references by external agents;
selectively responding to memory references made to memory held in the cache;
selectively updating a cache line state in the snoop proxy; and
selectively appending a snoop to the queue.

3. The method of claim 2 wherein the snoop proxy comprises logic and state memory outside the cache.

4. The method of claim 3 wherein the logic and state memory is a small addition to a core-valid structure in a higher level inclusive cache.

5. The method of claim 3 wherein the logic and state memory is a snoop filter for one of a non-inclusive cache and a last-level cache.

6. The method of claim 2 wherein tracking of memory references by external agents further comprises maintaining the state of cache tags having lines in the cache.

7. The method of claim 1 wherein the deferred snoops are processed before any agents behind the cache access memory through the cache.

8. The method of claim 1 wherein some initialization of logic behind the cache occurs in parallel with the processing of the deferred snoops.

9. An integrated circuit for retaining coherent cache contents, comprising:
a processor that, during a power-down operation, one of flushes and cleans each modified cache line in a cache;
a snoop proxy that, while the cache is in a powered-down state, defers incoming snoops, and, upon the cache exiting the powered-down state, directs processing of the deferred snoops.

10. The integrated circuit of claim 9 wherein the snoop proxy:
captures deferred snoops by external agents in a queue;
tracks contents of the cache; and
selectively responds to the snoops according to whether the cache contains data corresponding to the snoops, a type of snoop requested, and a power state of the cache.

11. The integrated circuit of claim 10 wherein the response to the snoop further comprises changing the power state of at least one of a processor core and the cache.

12. The integrated circuit of claim 9 wherein the snoop proxy comprises logic and state memory outside the cache.

13. The integrated circuit of claim 12 wherein the logic and state memory is a small addition to a core-valid structure in a higher level inclusive cache.

14. The integrated circuit of claim 12 wherein the logic and state memory is a snoop filter for one of a non-inclusive cache and a last-level cache.

15. The integrated circuit of claim 9 wherein the deferred snoops are processed before any agents behind the cache access memory through the cache.

16. The integrated circuit of claim 9 wherein some initialization of logic behind the cache occurs in parallel with the processing of the deferred snoops.

17. A system for retaining coherent cache contents, comprising:
a processor executing instructions to:
during a power-down operation, one of flush and clean each modified cache line in a cache;
while in a powered-down state, defer incoming snoops; and
upon exiting the powered-down state, process the deferred snoops.

18. The system of claim 17 wherein deferring the incoming snoops further comprises:
capturing deferred snoops in a queue;
with a snoop proxy:
tracking contents of the cache;
tracking memory references by external agents;
selectively responding to memory references made to memory held in the cache;
selectively updating a cache line state in the snoop proxy; and
selectively appending a snoop to the queue.

19. A system for retaining coherent cache contents, comprising:
means for, during a power-down operation, one of flushing and cleaning each modified cache line in a cache;
means for, while in a powered-down state, deferring incoming snoops; and
means for, upon exiting the powered-down state, processing the deferred snoops.

20. The system of claim 19 wherein the means for deferring further comprises:
a queue that captures deferred snoops; and
a snoop proxy that:
tracks contents of the cache;
tracks memory references by external agents;
selectively responds to memory references made to memory held in the cache;
selectively updates a cache line state in the snoop proxy; and
selectively appends a snoop to the queue.
